(19) United States
(12) Patent Application Publication
(10) Pub. No.: US 2015/0158731 A1
(43) Pub. Date: Jun. 11, 2015

(54) LINING FOR SURFACES OF A REFRACTORY CRUCIBLE FOR PURIFICATION OF SILICON MELT AND METHOD OF PURIFICATION OF THE SILICON MELT USING THAT CRUCIBLE

(71) Applicant: Silicor Materials, Inc., San Jose, CA (US)

(72) Inventors: Alain Turenne, Kitchener (CA); Christain Alfred, Brampton (CA)

(21) Appl. No.: 14/409,538

(22) PCT Filed: Jun. 24, 2013
(86) PCT No.: PCT/US2013/047312

§ 371 Date: Dec. 19, 2014

Related U.S. Application Data
(60) Provisional application No. 61/663,934, filed on Jun. 25, 2012.

(51) Int. Cl. C01B 33/037; B01J 6/00

(52) U.S. Cl. CPC C01B 33/037; B01J 6/007

(57) ABSTRACT

A crucible for containing molten silicon comprises at least one refractory material having at least one inner surface defining an interior for receiving a molten silicon mixture, and a lining deposited onto the inner surface, the lining comprising colloidal alumina. A method for silicon purification comprises contacting a first silicon with a solvent metal comprising aluminum, sufficient to provide a first mixture, melting the first mixture in an interior of a melting crucible to provide a molten silicon mixture, the melting crucible comprising at least one refractory material having an inner surface defining the interior of the melting crucible, coating at least a portion of the inner surface of the melting crucible with a lining comprising colloidal alumina prior to melting first mixture, cooling the molten silicon mixture, sufficient to form recrystallized silicon crystals and a mother liquor, and separating the final recrystallized silicon crystals and the mother liquor.

### CROSS-REFERENCE TO RELATED APPLICATIONS

This application claims the benefit of priority to U.S. Provisional Application No. 61/663,934, filed Jun. 25, 2012, which is herein incorporated by reference in its entirety.

### BACKGROUND

Solar cells can be a viable energy source by utilizing their ability to convert sunlight to electrical energy. Silicon is a semiconductor material used in the manufacture of solar cells; however, a limitation of silicon use relates to the cost of purifying it to solar grade (SG). Efficient methods of separating impurities from silicon, especially on a large-scale, are often elusive and difficult to employ.

Recrystallization of silicon is one method that can be used to remove undesired impurities. In a recrystallization process, silicon with impurities is dissolved in a solvent and then caused to recrystallize back out of the solution, forming a purer silicon.

### SUMMARY

In view of current energy demands and supply limitations, the present inventors have recognized a need for a more cost efficient way of purifying metallurgical grade (MG) silicon (or any other silicon having a greater amount of impurities than solar grade) to solar grade silicon. The present disclosure describes an apparatus and method for recrystallization of silicon. The apparatus can comprise a vessel, such as a crucible, made from a refractory material, such as alumina. The silicon can be melted in the crucible or silicon can be recrystallized from solution within the crucible to provide for purification of the silicon. A lining can be deposited on an inner surface of the refractory material of the crucible in order to prevent or reduce contamination of the molten silicon or silicon and aluminum solution contained within the crucible from the refractory material, such as contamination from boron or phosphorous. The lining can include silicon carbide particles bound together by a colloidal alumina. The lining can provide for a more pure final silicon for each crystallization cycle, particularly with respect to boron and phosphorus contaminants.

The present disclosure describes a crucible for containing a molten silicon mixture, the crucible comprising at least one refractory material having at least one inner surface defining an interior for receiving a molten silicon mixture, and a lining deposited onto the inner surface, the lining comprising colloidal alumina.

The present disclosure also describes a method for the purification of silicon, the method comprising contacting a first silicon with a solvent metal comprising aluminum, sufficient to provide a first mixture, melting the first mixture in an interior of a melting crucible to provide a molten silicon mixture, the melting crucible comprising at least one refractory material having an inner surface defining the interior of the melting crucible, coating at least a portion of the inner surface of the melting crucible with a lining comprising colloidal alumina prior to melting first mixture, cooling the molten silicon mixture, sufficient to form recrystallized silicon crystals and a mother liquor, and separating the final recrystallized silicon crystals and the mother liquor.

The present disclosure also describes a method for the purification of silicon, the method comprising contacting a first silicon with a first solvent metal, sufficient to provide a first mixture, coating at least a portion of a first inner surface of a first refractory of a first melting crucible with a first lining comprising colloidal alumina, melting the first mixture in an interior of the first melting crucible to provide a first molten silicon mixture, cooling the first molten silicon mixture, sufficient to form first silicon crystals and a first mother liquor, separating the first silicon crystals and the first mother liquor, contacting the first silicon crystals with a second solvent metal, sufficient to provide a second mixture, coating at least a portion of a second inner surface of a second refractory of a second melting crucible with a second lining comprising colloidal alumina, melting the second mixture in an interior of the second melting crucible to provide a second molten silicon mixture, cooling the second molten silicon mixture, sufficient to form second silicon crystals and a second mother liquor, and separating the second silicon crystals and the second mother liquor.

This summary is intended to provide an overview of subject matter of the present disclosure. It is not intended to provide an exclusive or exhaustive explanation of the invention. The detailed description is included to provide further information about the present disclosure.

### BRIEF DESCRIPTION OF THE DRAWINGS

In the drawings, like numerals can be used to describe similar elements throughout the several views. Like numerals having different letter suffixes can be used to represent different views of similar elements. The drawings illustrate generally, by way of example, but not by way of limitation, various examples discussed in the present document.

FIG. 1 is a block flow diagram of an example method of purifying silicon via a one-pass recrystallization process.

FIG. 2 is a block flow diagram of an example method of purifying silicon via a two-pass recrystallization process.

FIG. 3 is a block flow diagram of an example method of purifying silicon via a three-pass recrystallization process.

FIG. 4 is a cross-sectional view of an example of a crucible that can be used for the purification of silicon.

FIG. 5 is a close-up cross-sectional view of a first example of a lining coated on an inner surface of the example crucible of FIG. 4.

FIG. 6 is a close-up cross-sectional view of a second example of a lining coated on an inner surface of the example crucible of FIG. 4.

### DETAILED DESCRIPTION

This disclosure describes an apparatus and method for purifying silicon using crystallization. The apparatus and method can include the use of a lining within a crucible that holds molten silicon or a solution of a molten solvent, such as aluminum, and silicon, wherein the lining can prevent or reduce contamination of the molten silicon or molten solvent and silicon from a refractory material of the crucible. The apparatus and method of the present invention can be used to make silicon crystals for use in solar cells.

### DEFINITIONS

The singular forms “a,” “an” and “the” can include plural referents unless the context clearly dictates otherwise.

As used herein, in some examples, terms such as “first,” “second,” “third,” and the like, as applied to other terms such as “mother liquor,”, “crystals,” “molten mixture,” “mixture,” “rinse solution,” “molten silicon,” and the like, are used simply as generic terms of differentiation between steps, and do not by themselves indicate priority of steps or order of steps, unless otherwise clearly indicated. For example, in some examples a “third mother liquor” may be an element, while no first or second mother liquor may be elements of the example. In other examples, a first, second, and third mother liquor may all be elements of an example.

As used herein, “contacting” can refer to the act of touching, making contact, or of bringing substances into immediate proximity.

As used herein, “crucible” can refer to a container that can hold molten material, such as a container that can hold material as it is melted to become molten, a container that can receive the molten material and maintain the material in its molten state, and a container that can hold molten material as it solidifies or crystallizes, or a combination thereof.

As used herein, “crystal” can refer to a solid having a highly regular structure. A crystal can be formed by the solidification of elements or molecules.

As used herein, “crystalline” can refer to a regular, geometric arrangement of atoms in a solid.

As used herein, “crystallizing” can refer to a process of forming crystals (crystalline material) of a substance, from solution. The process separates a product from a liquid feed, often in extremely pure form, by cooling the feed or adding precipitants that lower the solubility of the desired product so that it forms crystals. The pure solid crystals are then separated from the remaining liquor by decantation, filtration, centrifugation or other means.

As used herein, “dross” can refer to a mass of solid impurities floating on a molten metal bath. It appears usually on the melting of low melting point metals or alloys such as tin, lead, zinc or aluminum, or by oxidation of the metal(s). It can be removed, e.g., by skimming it off the surface. With tin and lead, the dross can also be removed by adding sodium hydroxide pellets, which dissolve the oxides and form a slag. With other metals, salt fluxes can be added to separate the dross. Dross is distinguished from slag, which is a (viscous) liquid floating on the alloy, by being solid.

As used herein, “flux” can refer to a compound that is added to a molten metal bath to aid in the removal of impurities, such as within a dross. A flux material can be added to the molten metal bath so that the flux material can react with one or more materials or compounds in the molten metal bath to form a slag that can be removed.

As used herein, “furnace” can refer to a machine, device, apparatus, or other structure that has a compartment for heating a material.

As used herein, “ingot” can refer to a mass of cast material. In some examples, the shape of the material allows the ingot to be relatively easily transported. For example, metal heated past its melting point and molded into a bar or block can be referred to as an ingot.

As used herein, “melt” or “melting” can refer to a substance changing from a solid to a liquid when exposed to sufficient heat. The term “melt” can also refer to a material that has undergone this phase transition to become a molten liquid.

As used herein, “mixture” can refer to a combination of two or more substances in physical contact with one another. For example, components of a mixture can be physically combined as opposed to chemically reacting.

As used herein, “molten” can refer to a substance that is melted, wherein melting is the process of heating a solid substance to a point (called the melting point) where it turns into a liquid.

As used herein, “monocrystalline silicon” can refer to silicon that has a single and continuous crystal lattice structure with almost no defects or impurities.

As used herein, “mother liquor” or “mother liquid” can refer to the liquid or molten liquid obtained after solids (e.g., crystals) are removed from a mixture of a solution of solids in a liquid. Depending on the thoroughness of the removal, the mother liquor can include an unappreciable amount of these solids.

As used herein, “polycrystalline silicon” or “poly-Si” or “multicrystalline silicon” can refer to a material including multiple monocrystalline silicon crystals.

As used herein, “purifying” can refer to the physical or chemical separation of a chemical substance of interest from foreign or contaminating substances.

As used here, “recrystallization” can refer to a process of dissolving an impure material in a solvent and crystallizing the material back out of the solvent, such that the material that is crystallized back out of the solvent has a higher purity than the impure material that was dissolved in the solvent.

As used herein, “refractory material” can refer to a material which is chemically and physically stable at high temperatures, particularly at high temperatures associated with melting and directionally solidifying silicon. Examples of refractory materials include but are not limited to aluminum oxide, silicon oxide, magnesium oxide, calcium oxide, zirconium oxide, chromium oxide, silicon carbide, graphite, or a combination thereof.

As used herein, “side” or “sides” can refer to one or more sides, and unless otherwise indicated can refer to the side or sides or an object as contrasted with one or more tops or bottoms of the object.

As used herein, “silicon” can refer to the element Si, and can refer to Si in any degree of purity, but generally can refer to silicon that is at least 50% by weight pure, preferably 75% by weight pure, more preferably 85% pure, more preferably 90% by weight pure, and more preferably 95% by weight pure, and even more preferably 99% by weight pure.

As used herein, “separating” can refer to the process of removing a substance from another (e.g., removing a solid or a liquid from a mixture). The process can employ any suitable technique known to those of skill in the art, e.g., decanting the mixture, skimming one or more liquids from the mixture, centrifuging the mixture, filtering the solids from the mixture, or a combination thereof.

As used herein, “slag” can refer to by-product of smelting ore to purify metals. They can be considered to be a mixture of metal oxides; however, they can contain metal sulfides and metal atoms in the elemental form. Slags are generally used as a waste removal mechanism in metal smelting. In nature, the ores of metals such as iron, copper, lead, aluminum, and other metals are found in impure states, often oxidized and mixed in with silicates of other metals. During smelting, when the ore is exposed to high temperatures, these impurities are separated from the molten metal and can be removed. The collection of compounds that is removed is the slag. A slag can also be a blend of various oxides and other materials created by design, such as to enhance the purification of the metal.

As used herein, “solvent” can refer to a liquid that can dissolve a solid, liquid, or gas. Nonlimiting examples of solvents are molten metals, silicones, organic compounds, water, alcohols, ionic liquids, and supercritical fluids.

As used herein, “solvent metal” can refer to one or more metals, or an alloy thereof, which upon heating, can effectively dissolve silicon, resulting in a molten liquid. Suitable exemplary solvent metals include, e.g., copper, tin, zinc, antimony, silver, bismuth, aluminum, cadmium, gallium, indium, magnesium, lead, an alloy thereof, and combinations thereof.

As used herein, “tube” can refer to a hollow pipe-shaped material. A tube can have an internal shape that approximately matches its outer shape. The internal shape of a tube can be any suitable shape, including round, square, or a shape with any number of sides, including non-symmetrical shapes.

Recrystallizing Silicon

A method of purifying silicon can include dissolving a starting-material silicon in a molten solvent, such as a molten solvent metal, for example a molten solvent metal comprising aluminum, and recrystallizing silicon from the molten solvent to provide recrystallized silicon crystals. The recrystallizing can be any suitable recrystallization process, wherein the recrystallization solvent can include aluminum, to provide recrystallized silicon crystals that are more pure than the starting-material silicon. In an example, a single recrystallization can be performed to purify the starting-material silicon as recrystallized silicon crystals. In another example, the starting-material silicon can be recrystallized multiple times before providing final recrystallized silicon crystals. The aluminum solvent can be pure, or can include impurities. Impurities in the aluminum can be silicon or other impurities.

In examples with multiple recrystallizations, the recrystallizations can be a cascading process, wherein the aluminum solvent can be recycled back through the process, such that the first recrystallization uses the least pure aluminum as the recrystallization solvent, and the last recrystallization uses the most pure aluminum as the recrystallization solvent. As silicon crystals move forward through the cascading process, the silicon crystals can be recrystallized from purer solvent metal. By recycling the aluminum solvent, waste can minimized. Since the amount of impurities in the solvent and in the material being recrystallized can negatively affect the purity of the product, using the purest aluminum solvent for the last recrystallization can help to maximize the purity of the final recrystallized silicon crystals. Examples of a suitable recrystallization process can be found in U.S. patent application Ser. No. 12/729,561, filed on Mar. 23, 2010, and U.S. Provisional Patent Application 61/591,073, filed on Jan. 26, 2012, which are herein incorporated by reference in their entirety.

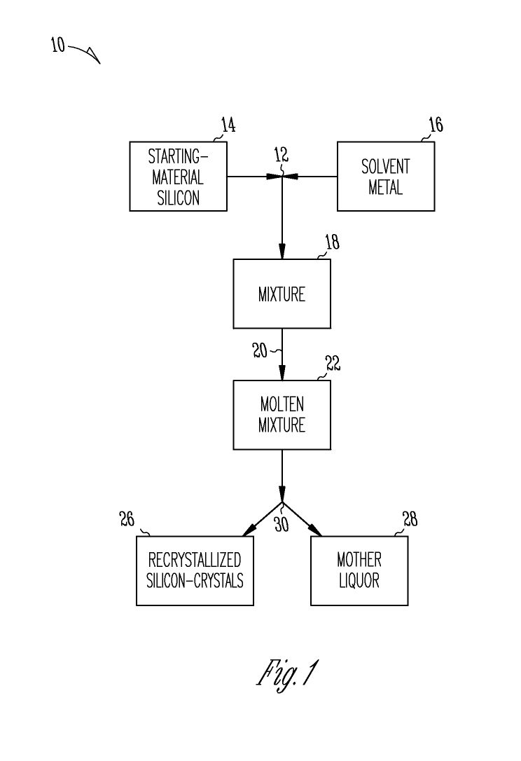

FIG. 1 is a block flow diagram of an example method 10 of purifying silicon via recrystallization. The recrystallization method 10 can include contacting 12 a starting-material silicon 14 with a solvent metal 16, wherein the solvent metal 16 can include aluminum. The contacting 12 can be sufficient to provide a mixture 18. The mixture 18 can be melted 20, such as in a crucible or other vessel (described below), sufficient to provide a molten mixture 22. The recrystallization method 10 can include cooling 24 the molten mixture 22, sufficient to form recrystallized silicon crystals 26 and a mother liquor 28. The recrystallization method 10 can include separating 30 the recrystallized silicon crystals 26 and the mother liquor 28, sufficient to provide the recrystallized silicon crystals 26. The recrystallizing method 10 described with respect to FIG. 1 can be referred to as “one-pass” or “single-pass” recrystallization.

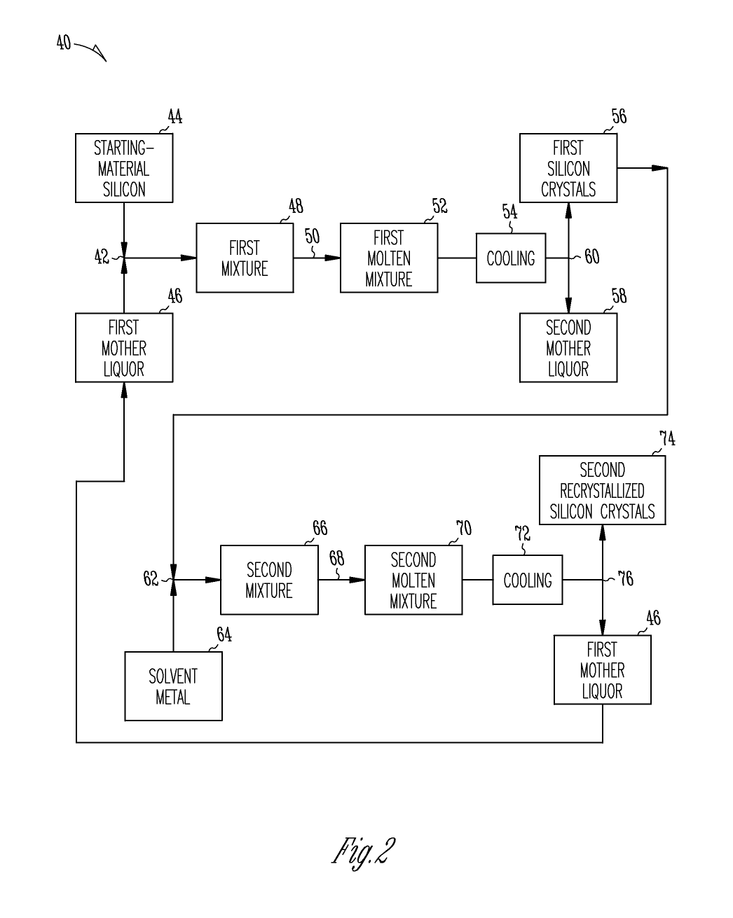

FIG. 2 is a block flow diagram of another example method 40 of purifying silicon via recrystallization. The recrystallizing method 40 can comprise a cascading process that can include contacting 42 a starting-material silicon 44 with a first mother liquor 46, sufficient to provide a first mixture 48. The recrystallizing method 40 can include melting 50 the first mixture 48, sufficient to provide a first molten mixture 52. The method can include cooling 54 the first molten mixture 52, sufficient to form first silicon crystals 56 and a second mother liquor 58. The recrystallizing method 40 can include separating 60 the first silicon crystals 56 and the second mother liquor 58, to provide the first silicon crystals 56.

The recrystallizing method 40 can include contacting 62 the silicon crystals 56 with a solvent metal 64, wherein the solvent metal 64 can comprise aluminum, sufficient to provide a second mixture 66. The recrystallizing method 40 can include melting 68 the second mixture 66, sufficient to provide a second molten mixture 70. The recrystallizing method 40 can include cooling 72 the second molten mixture 70, sufficient to form second recrystallized silicon crystals 74 and the first mother liquor 46. The method can also include separating 76 the second recrystallized silicon crystals 74 and the first mother liquor 46, to provide the second recrystallized silicon crystals 74. The recrystallizing method 40 described with respect to FIG. 2 can be referred to as a “two-pass” or a “double-pass” recrystallization cascade.

It is to be understood that all discussion below regarding a three-pass or greater recrystallization cascade and variations thereof applies also to a two-pass recrystallization cascade examples, such as that illustrated in FIG. 2. When applicable, all discussion herein regarding a three-pass or greater recrystallization cascade and variations thereof also applies to one-pass recrystallization, such as that illustrated in FIG. 1.

In an example, the recrystallization of starting-material silicon can include contacting the starting-material silicon with a second mother liquor. The contacting can be sufficient to provide a first mixture. The method can include melting the first mixture, sufficient to provide a first molten mixture. The method can include cooling the first molten mixture, sufficient to form first silicon crystals and a third mother liquor. The method can include separating the first silicon crystals and the third mother liquor, sufficient to provide the first silicon crystals. The method can include contacting the first silicon crystals and a first mother liquor, sufficient to provide a second mixture. The method can include melting the second mixture, sufficient to provide a second molten mixture. The method can include cooling the second molten mixture, sufficient to form second silicon crystals and the second mother liquor. The method can include separating the second silicon crystals and the second mother liquor, sufficient to provide the second silicon crystals. The method can include contacting the second silicon crystals with a first solvent metal comprising aluminum, sufficient to provide a third mixture. The method can include melting the third mixture, sufficient to provide a third molten mixture. The method can include cooling the third molten mixture to form final recrystallized silicon crystals and the first mother liquor. The method can include separating the final recrystallized silicon crystals and the first mother liquor, to provide the final recrystallized silicon crystals.

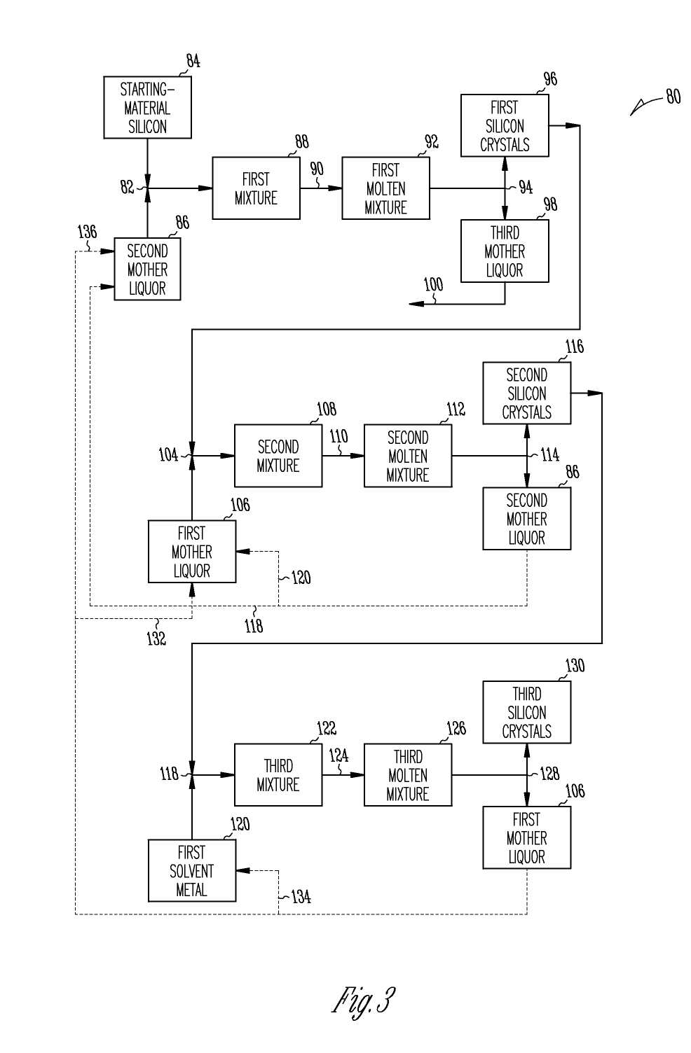

FIG. 3 shows a block flow diagram of another example method 80 of purifying silicon via a recrystallization cascade process. The recrystallization method 80 can include contacting 82 a starting-material silicon 84 (e.g., a first silicon) with a solvent metal including aluminum, such as a second mother liquor 86, sufficient to form a first mixture 88. The first mixture 88 can be melted 90 to form a first molten mixture 92, which can then be cooled and separated 94 into first silicon crystals 96 and a mother liquor such as a third mother liquor 98. The third mother liquor 98 can be removed from the process 100 and sold for use in other industries, or all or a portion of the third mother liquor 98 can be recycled 102 back with the second mother liquor 86. An example of an industry for which the third mother liquor 98 can be of value can include, but is not limited to, the aluminum foundry industry for use in aluminum silicon alloys for castings.

The feedstock, e.g., the starting-material silicon, can comprise a metallurgical-grade silicon. The metallurgical-grade silicon can include less than about 15 ppmw boron, less than about 10 ppmw boron, or less than about 6 ppmw boron, for example. The solvent metal can be aluminum. The aluminum can be P1020 aluminum and include a boron level of less than about 1.0 ppmw, less than about 0.6 ppmw, or less than about 0.4 ppmw.

The contacting of silicon or silicon crystals to a mother liquor or a solvent metal can occur in any suitable manner. The manner of contacting can include adding the silicon or silicon crystals to a mother liquor, and can also include adding the mother liquor to the silicon or silicon crystals. Methods of addition that avoid splashing or that avoid loss of material are encompassed by the envisioned manners of contacting. The contacting can be performed with or without stirring or agitation. The contacting can generate agitation. The contacting can be designed to generate agitation. The contacting can occur with or without heating. The contacting can generate heat, can be endothermic, or can generate no heat or loss of heat.

Optional stirring or agitation can be performed in any suitable manner. Stirring can include mechanical stirring with paddles or other stirring devices. Agitation can include agitating by the injecting and bubbling of gases, and can also include the physical agitation of a container, including swirling or shaking. The addition of one material to another can cause agitation, and the manner of addition can be designed such as to produce agitation. The injection of a liquid into another liquid can also produce agitation.

The melting of a mixture of silicon or silicon crystals in a mother liquor or a solvent metal can occur in any suitable manner. The manner of melting can include adding heat to the mixture by any suitable method to cause the desired melting of the silicon or silicon crystals. The heating can continue after a molten mixture has been achieved. The manner of melting can be conducted with or without agitation. The manner of melting can also include the silicon or silicon crystals melting as a result of being exposed to a mother liquor or solvent metal that is at a high enough temperature, e.g., at a temperature at or above the melting point of the silicon or silicon crystals; thus, the contacting of silicon or silicon crystals with a mother liquor or a solvent metal to produce a mixture can be combined with the step of melting the mixture of silicon or silicon crystals to provide a molten mixture. The melting temperature of a mixture can be inconsistent or variable, changing as the composition of the molten material changes.

Methods of adding heat to a mixture can include any suitable method. These methods can include, but are not limited to, heating with a furnace or heating by injecting hot gases into a mixture or heating with a flame generated from burning gases. Inductive heating can be used. The method of heating can be radiant heat. The method of heating can be by the conduction of electricity through the material to be heated. Also included is the use of plasma to heat, the use of an exothermic chemical reaction to heat, or the use of geothermal energy to heat. The mixing of the silicon or silicon crystals with the mother liquor or solvent metal can, depending of the impurities of the silicon and the content of the mother liquor, produce heat or absorb heat, which can in some examples result in the corresponding adjustment of the source of heating being beneficial.

Optionally, gas can be injected into the molten mixture before cooling, including chlorine gas, other halogen gas or halide-containing gas, or any suitable gas. The cooling of the molten mixture can be conducted in any suitable manner known to those of skill in the art. Included are cooling by removal from a source of heat, which includes cooling by exposure to room temperature or to temperatures below the temperature of the molten mixture. Included are cooling by pouring into a non-furnace container and being allowed to cool at below-furnace temperatures. In some examples, the cooling can be rapid; however, in other examples, the cooling can be gradual, therefore it can be advantageous to expose the cooling molten mixture to a source of cooling that is only incrementally lower than the current temperature of the molten mixture. The source of cooling can be gradually lowered in temperature as the molten mixture is cooled, and in some cases this could be achieved via sensitive or general monitoring of the temperature of the molten mixture as it is cooled. The purity of the resulting crystallized silicon can improve by cooling the mixture as slowly as possible, therefore all suitable manners of gradual cooling are envisioned to be encompassed by the present invention. Also included are more rapid methods of cooling, including refrigeration mechanisms. Exposure of the container holding the molten material to cooler materials, such as a liquid cooler than the molten mixture, such as water, or such as another molten metal, or such as a gas, including ambient or refrigerated air, are included. The addition of cooler materials to the molten mixture are included, such as the addition of another cooler mother liquor, or the addition of a cooler solvent metal, or the addition of another cooler material that can be removed from the mixture later, or that alternatively can be left in the mixture.

The mother liquor resulting from the cooling of a molten mixture and subsequent separation of silicon crystals and the mother liquor is envisioned to be optionally recycled to any prior step in the process. Once crystallization of silicon has occurred from a mother liquor, generally at least some amount of silicon will remain dissolved in the mother liquor, along with the impurities which are desired to stay dissolved in the mother liquor. To cool the molten mixture to a point where all or most of the silicon is crystalline can be in some cases not possible, or can negatively impact the purity of the resulting silicon crystals, or can be inefficient. In some examples, the purity of the silicon crystals produced by only allowing less than all, or less than a majority, of the silicon to crystallize out of a molten mixture, can be significantly or at least partially improved. The energy required to heat and melt solvent metal can be economically inefficient, compared to combining hot mother liquors with mother liquors in prior steps, or compared to reusing hot mother liquors. The energy required to cool a molten mixture to a certain temperature in order to attain a certain yield of silicon crystals can be inefficient compared to not cooling the mother liquor to such a low temperature and accepting a lower yield of silicon crystals but then recycling the mother liquor.

The advantageous leaving of desired and undesired materials in the mother liquors is envisioned to be encompassed by some examples. Thus, in some examples the recycling of mother liquor to be used again in the same crystallization step or in earlier crystallization steps is a sometimes useful aspect. By recycling mother liquors, the silicon that is still present in the mixture of the mother liquor is conserved and wasted less than if the mother liquor is simply discarded or sold as by-product. In some examples the same or nearly the same degree of purity of silicon crystals can be achieved using a recycled mother liquor, or by using a mother liquor that has some recycled mother liquor in it, than if the mother liquor had no recycled mother liquor, or even than if the solvent from which crystallizing was occurring was pure solvent metal. Therefore, all degrees and variations of the recycling of mother liquors are encompassed within the scope of the present invention.

The separation of the mother liquor from the silicon solids can take place by any suitable method known to those of skill in the art. Any variation of draining or siphoning the liquid solvent away from the desired solids are encompassed within examples of the methods described herein. These methods include decantation, or the pouring of the mother liquor away from the desired solids. For a decantation, the desired solids can be held in place by gravity, by adhesion to themselves or to the sides of the container, by the use of a grate or mesh-like divider that selectively holds back solids, or by applying physical pressure to the solids to hold them in place. Methods of separation include centrifugal separation. Also included are filtration, using any filter medium, and with or without the use of a vacuum, and with or without the use of pressure. Also included are chemical means, such as dissolution or chemical transformation of the solvent, including using acid or base.

Returning to FIG. 3, the first silicon crystals 96 can be contacted 104 with a solvent metal, such as a first mother liquor 106 to form a second mixture 108. The second mixture 108 can be melted 110 to form a second molten mixture 112. The second molten mixture 112 can be cooled and separated 114 into second silicon crystals 116 and the second mother liquor 86. All or a portion of the second mother liquor 86 can then be recycled 118 back in the process to contact 82 the starting-material silicon 84 or all or a portion of the second mother liquor 104 can be recycled 120 back to the first mother liquor 106. The steps from contacting 104 the first silicon crystals 96 with the first mother liquor 106 to obtaining the second silicon crystals 116 can be optional, in that they can be either skipped or these steps can be performed a number of times (e.g. 1, 2, 3, 4, etc.). If these steps are not performed, the recrystallization method 80 can be a two pass process, similar to the method 40 described above with respect to FIG. 2, and the first silicon crystals 96 can then subsequently be contacted with a first solvent metal 120.

The second silicon crystals 116 can be contacted 118 with a first solvent metal 120, such as a solvent metal 126 including aluminum, to form a third mixture 122. The third mixture 122 can be melted 124 to form a third molten mixture 126. The third molten mixture 126 can then be cooled and separated 128 into final recrystallized silicon crystals 130 (e.g. third silicon crystals 130) and the first mother liquor 106. All or a portion of the first mother liquor 106 can then be directed back 132 in the process to contact the first silicon crystals 96. All or a portion of the first mother liquor 106 can be recycled 134 back to the first solvent metal 120. The batch or continuous recycling 134 of all or part of the first mother liquor 106 back to the first solvent metal 120 can cause the first solvent metal 120 to include solvent metal that is less than completely pure because of dilution with mother liquor. All or a portion of the first mother liquor 106 can be alternatively or additionally recycled 136 back to the second mother liquor 86. All variations of the steps of recycling of mother liquors are included within the scope of the present invention.

Forming the first silicon crystals 96 can be called a “first pass.” Forming the second silicon crystals 116 can be called a “second pass.” Forming the third silicon crystals 130, e.g., the final recrystallized silicon crystals 130, can be called a “third pass.” There is no limit to the number of passes envisioned within the method of the present invention.

A pass can be repeated in order to more efficiently use the mother liquor by increasing the number of crystallizations achieved from a mother liquor, by increasing the amount of silicon recovered from the mother liquor, or by increasing the yield of silicon crystals before entering the next pass in the process, and there is no limit to the number of repetitions of a pass envisioned within the method of the present invention. If a repeated pass is performed, the respective mother liquor can be reused in all or in part in repetitions of that pass. A repeated pass can be performed sequentially, or in parallel. If a repeated pass is performed sequentially, it can be performed in one single container, or it can be performed in several containers in sequence. If a repeated pass is performed in parallel, several containers can be used, allowing several crystallizations to occur in parallel. The terms “sequence” and “parallel” are not intended to rigidly restrict the order in which the steps are performed, by rather to approximately describe doing steps one at a time or near to the same time.

A repeated pass, e.g. a repetition of the first, second, third, or of any pass, can more efficiently make use of several mother liquors of decreasing purity including by reusing all or part of a mother liquor in a pass. To make an existing mother liquor more pure, one way can be to add additional solvent metal (that is more pure than the mother liquor) to the mother liquor. Adding another more pure mother liquor to the mother liquor can be another way to increase its purity, such as that derived from, e.g., a later crystallization step in the process. Part or all of the mother liquor that has been used in a particular pass can also be discarded or used in an earlier pass or used in an earlier repetition of the same pass.

One possible reason for the repetition of passes and corresponding reuse of mother liquors can be to make the mass balance for the cascading steps even out for part or all of the entire process. Silicon of suitable purity can be added to any stage of the cascade, and can be added with or without silicon from a prior pass, and as with the repetition of the steps, one possible reason to do this can be to make the mass balance of the cascading steps balance in part or in whole.

The mother liquor can be entirely reused without any enhancement of purity of the mother liquor in a repeated pass. Alternatively, the mother liquor can be partially reused with enhancement of purity in a repeated pass, using more pure solvent metal or mother liquor from a subsequent step to enhance the purity of the mother liquor. For example, a first pass could be repeated in parallel, using two different containers, with mother liquor flowing toward the beginning of the process from the first instance of the pass to the first repetition of the pass, with silicon being added to both the first instance of the pass and the repeated instance of the pass, and with silicon being removed from both the first instance of the pass and the repetition of the pass to be carried on to subsequent passes. In another example, a first pass could be repeated in parallel, using two different containers, with part of the mother liquor flowing towards the beginning of the process from the first instance of the pass to the first repetition of the pass, and with another part of the mother liquor flowing towards the beginning of the process to a prior step without being reused in the repetition of the pass, with silicon being added to both the first instance of the pass and the repeated instance of the pass, and with silicon being removed from both the first instance of the pass and the repetition of the pass to be carried on to subsequent passes.

Also, a first pass could be repeated in sequence, using one container, in which after the first crystallization and separation, part of the used mother liquor from that pass is retained for reuse and some mother liquor from a later pass is added, and in the repeated pass another crystallization is performed with additional silicon. After the repetition, the mother liquor can entirely move on to another prior step. Alternatively, after the repetition, only part of the mother liquor can move on to another prior step, with the rest of the mother liquor being retained for reuse in the pass. At least part of the mother liquor can eventually be moved on to a prior step, otherwise the impurities of that mother liquor can build to intolerable levels, and also the mass balance of the cascade can be difficult to maintain. In another example, a first pass could be repeated in sequence, using one container, in which after the first crystallization and separation, all of the used mother liquor from that pass is retained for reuse in the repeated pass, and in the repeated pass another crystallization is performed with additional silicon.

A subsequent pass can be performed in the same or different container or as the prior pass. For example, the first pass can occur in the same container as the second pass. Or, the first pass can occur in a different container as the second pass. A pass can be repeated in the same container. For example, the first instance of the first pass could occur in a particular container, and then the first repetition of the first pass could occur in the same container. The economies of large scale processing can make reuse of the same container for multiple subsequent or simultaneous passes advantageous in some examples. In some examples, it can be economically beneficial to move a liquid from container to container rather than to move a solid, therefore examples of the present invention encompass all variations of the reuse of containers and also all variations of the use of different containers. Therefore, a subsequent pass can be performed in a different container as the prior pass. A repeated pass can be performed in the same container as an earlier performance of that pass.

The impurities of the mother liquor as it moves towards the beginning of the process grow to higher concentrations, including in boron and in other impurities. The mother liquors can be reused as needed in each step of the crystallization (forming the crystals) to balance the mass throughout of the process. The number of reuses can be a function of the solvent metal (e.g., aluminum) to silicon ratio utilized, the desired chemistry, and the desired throughput of the system.

After forming and separating out the final recrystallized silicon crystals 130, residual solvent metal can be dissolved or otherwise removed from the crystals by using an acid, base or other chemical. Any powder, remaining solvent metal or foreign contaminant can be removed by mechanical means as well. Hydrochloric acid (HCl) can be used to dissolve solvent metal off of flakes or crystals of the final recrystallized silicon crystals 130. Spent HCl can be sold as polyaluminum chloride (PAC) or aluminum chloride to, among other things, treat waste water or drinking water. To dissolve aluminum off of the final recrystallized silicon crystals 130, a counter-current system can be used with multiple tanks moving flakes from clean to dirty, and acid from clean to spent, in opposite directions. A bag house can be used to pull loose powder away from flakes and V-grooved slots and vibration can be used to separate balls of powder, foreign contaminates or non-dissolved aluminum from the flakes after the acid leaching. The silicon can be further purified via a directional solidification process. An example of a directional solidification process is described in U.S. patent application Ser. No. 12/947,936 to Nichol et al., entitled “APPARATUS AND METHOD FOR DIRECTIONAL SOLIDIFICATION OF SILICON,” filed on Nov. 17, 2010, assigned to the assignee of this application, which is herein incorporated by reference in its entirety.

At any time during the methods disclosed herein, the silicon crystals or flakes, such as the first silicon crystals 96, the second silicon crystals 116, or the final recrystallized silicon crystals 130, can be melted and a gas or flux can be contacted with the molten silicon to provide for further purification, such as via the formation of a slag or a dross that can be removed. About 0.5-50 wt % flux can be added to the silicon. A flux containing some amount of SiO₂ can be utilized, for example. Other flux materials can be added, including, but not limited to, sodium carbonate (Na₂CO₃), calcium oxide (CaO), and calcium fluoride (CaF₂). Further description of flux compositions can be found in the U.S. Provisional Application to Turenne et al., entitled, “FLUX COMPOSITION USEFUL IN DIRECTIONAL SOLIDIFICATION FOR PURIFYING SILICON,” Attorney Docket No. 2552.036PRV, filed on the same date as this application, which is herein incorporated by reference in its entirety.

The silicon crystals or flakes can be melted in a furnace, which can include a flux addition, and flux addition can occur before or after melting the crystals or flakes. The crystals or flakes can be melted using flux addition. Flakes can be melted under vacuum, inert atmosphere or standard atmosphere. Argon can be pumped through the furnace to create an argon blanket or a vacuum furnace can be used. The flakes can be melted to above about 1410° C. The molten silicon can be held between about 1450° C. and about 1700° C. Slag or dross can be removed from the surface of the bath during slagging, while holding the silicon molten in the furnace, or during gas injection. In some examples, the molten silicon can be then poured into a mold for directional solidification. The molten silicon can be filtered through a ceramic filter first.

The mother liquor can be filtered with a ceramic foam filter or can be gas injected at any stage of the process. Ceramic materials low in contaminates, such as boron or phosphorus, are examples of materials that can be used to hold and melt the molten silicon. The gas can be oxygen, argon, water, hydrogen, nitrogen, chlorine, or other gases that contain these compounds can be used, or a combination thereof, for example. The gas can be injected through a lance, rotary degasser, or porous plug into the molten silicon. 100% Oxygen gas can be injected into the molten silicon. Gas can be injected for about 30 minutes to about 12 hours. Gases can be injected before, after, or during slagging. The gas can be 100% oxygen injected at 30-40 L/min through a lance into the molten silicon for 4 hours.

Crucible for Recrystallization

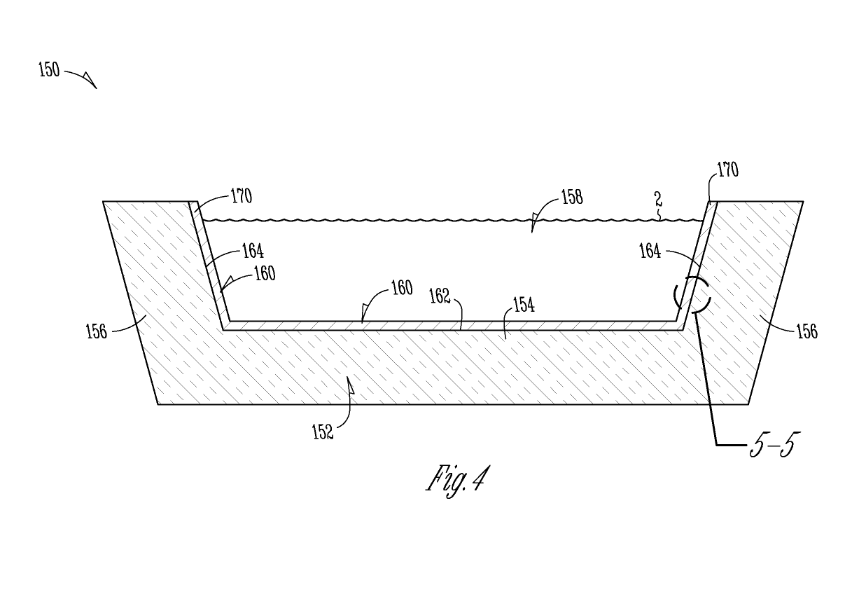

FIG. 4 shows an example of a crucible 150 according to the present disclosure. The crucible 150 can be used for one or more of the processing steps described with respect to the recrystallizing methods described above where a molten material will be present. For example, the crucible 150 can be used as a crucible for melting a mixture of silicon and a solvent, such as a solvent metal or a mother liquor, for example, the step of melting 20 the mixture 18 of the starting-material silicon 14 and the solvent metal 16 to form the molten mixture 22 described above with respect to FIG. 1. Similarly, the crucible 150 can be used as one of the passes of a multi-pass cascade process, such as in the second pass of the three-pass cascade method 80 described above with respect to FIG. 3, during the melting 110 of the second mixture 108 of the first silicon crystals 96 and the first mother liquor 106 to form the second molten mixture 112.

The crucible 150 can also be used as the vessel that contains a molten mixture while it is being cooled to recrystallize silicon, such as during the cooling 24 of the molten mixture 22 to form recrystallized silicon crystals 26 and the mother liquor 28, described above with respect to FIG. 1, or during the second pass cooling of the second molten mixture 112 to provide the second silicon crystals 116 and the second mother liquor 86, as described above with respect to FIG. 3. Any processing step that can include the formation or processing of a molten mixture or a molten silicon can use the crucible 150 of the present disclosure.

The crucible 150 can be formed from at least one refractory material 152 that can be configured to provide for melting of a material, such as a mixture 18, 48, 66, 88, 108, 122 to form a molten mixture 22, 52, 70, 92, 112, 126, or for cooling and crystallization of a material, such as the cooling of a molten mixture 22, 52, 70, 92, 112, 126 to form silicon crystals 26, 56, 74, 96, 116, 130 and a mother liquor 28, 58, 46, 86, 98, 106.

The crucible 150 can have a bottom 154 and one or more sides 156 extending upwardly from the bottom 154. The crucible 150 can be shaped similar to a thick-walled large bowl, which can have a circular or generally circular cross-section. The crucible 150 can have other cross-sectional shapes, including, but not limited to, a square shape, or a hexagon, octagon, pentagon, or any suitable shape, with any suitable number of edges.

The bottom 154 and sides 156 can define an interior 158 of the crucible 150 that can receive, form, or hold a molten material 2, such as a molten mixture or a mother liquor. The refractory material 152 can include an inner surface 160 that faces the interior 158 of the crucible 150. In an example, the inner surface 160 comprises an upper surface 162 of the bottom 154 and an inner surface 164 of the one or more sides 156.

The refractory material 152 can be any suitable refractory material, particularly a refractory material that is suitable for a crucible recrystallization of silicon. Examples of materials that can be used as the refractory material 152 include, but are not limited to aluminum oxide (Al₂O₃, also referred to as alumina), silicon oxide (SiO₂, also referred to as silica), magnesium oxide (MgO, also referred to as magnesia), calcium oxide (CaO), zirconium oxide (ZrO₂, also referred to as zirconia), chromium (III) oxide (Cr₂O₃, also referred to as chromia), silicon carbide (SiC), graphite, or a combination thereof. The crucible 150 can include one refractory material, or more than one refractory material. The refractory material or materials that are included in the crucible 150 can be mixed, or they can be located in separate parts of the crucible 150, or a combination thereof. The one or more refractory materials 152 can be arranged in layers. The crucible 150 can include more than one layer of one or more refractory materials 152. The crucible 150 can include one layer of one or more refractory materials 152. The sides 156 of the crucible 150 can be formed from a different refractory material or materials than the bottom 154. The sides 156 as compared to the bottom 154 of the crucible 150 can be different thicknesses, include different compositions of material, include different amounts of material, or a combination thereof.

Impurities can be passed from the refractory material 152 to the molten material 2 such that the impurity levels of some impurities can be higher than is acceptable for use of the silicon in photovoltaic devices. For example, boron or phosphorus impurities can be present in the refractory material 152. Even at very small boron or phosphorus levels, at the high temperatures experienced by the refractory material 152 due to the present of the molten material 2, the boron or phosphorus can be driven to diffuse out of the refractory material 12 and into the molten material 2.

A lining 170 can be deposited onto the inner surface 160 of the crucible 150, such as onto the upper surface 162 and the inner surface or surfaces 164. The lining 170 can be configured to prevent or reduce contamination of the molten material 2, such as via the transfer of impurities, such as boron (B) and phosphorus (P) from the refractory material 152 of the crucible 150 into the molten material 2. The lining 170 can provide a barrier to the contaminants or impurities that can be present within the refractory material 152.

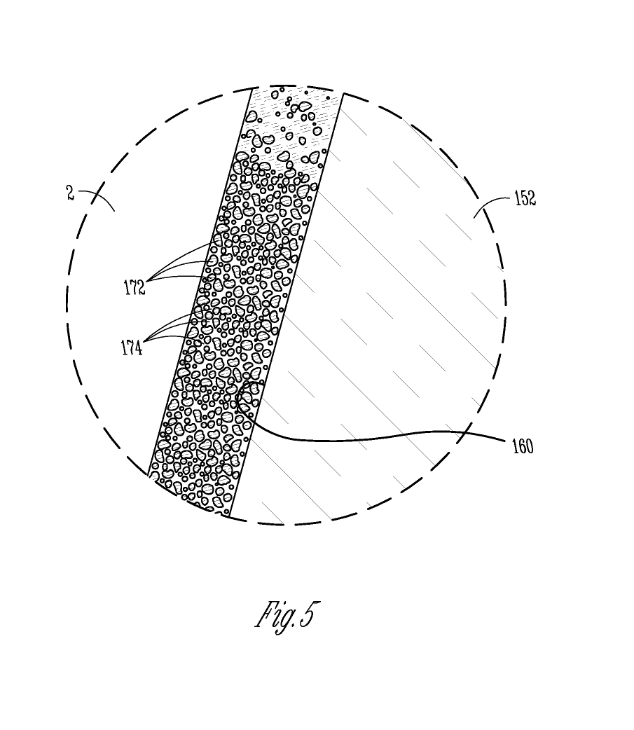

FIG. 5 shows a close-up cross-sectional view of an example of the lining 170A that can be deposited on the inner surface 160 of the refractory material 152. The lining 170A can be formed from a colloidal suspension of alumina (Al₂O₃), referred to herein as colloidal alumina. The colloidal alumina can comprise a suspension of small, amorphous alumina particles 172 suspended in a liquid phase 174. The colloidal alumina suspension can be deposited onto the inner surface 160 of the refractory material 152, such as by painting, spreading, or other common liquid deposition techniques. The colloidal alumina of the lining 170A can bind to the inner surface 160 and stabilize the lining 170A, even at the high temperatures associated with the presence of the molten material 2.

The colloidal alumina of the lining 170A can be formed via the formation of alumina nuclei, followed by growth of the alumina particles 172 within the liquid phase 174. In an example, an alkali aluminate solution, such as a sodium aluminate solution, is partially neutralized, such as by selective removing at least a portion of the sodium from the sodium aluminate. The neutralization of the alkali aluminate can lead to the formation of alumina nuclei and polymerization of the alumina to form amorphous alumina particles. The alumina nuclei can have a size of between 1 nanometer (nm) and 5 nm, inclusive. The resulting alumina particles 172 can have a size, e.g. a diameter, of between 1 nanometer (nm) and 100 nm, inclusive. In an example, the alumina particles 172 have a size of between 20 nm and 50 nm, inclusive, such as about 40 nm. In an example, the colloidal alumina that forms the lining 170A has a weight percentage of the alumina particles 172 that is between 25 wt % and 60 wt % alumina, inclusive, such as between 30 wt % and 50 wt % alumina, inclusive, for example 40 wt % alumina.

In an example, the colloidal alumina used to make the lining 170 is a commercially-available colloidal alumina, such as the colloidal alumina sold under the trade name WESOL by WesBond Corp., Wilmington, Del., USA.

In an example, the colloidal alumina that forms the lining 170A can be a liquid or liquid suspension that can be coated onto the inner surface 160 by known liquid coating methods. In an example, the colloidal alumina can be coated onto the inner surface 160 via at least one of painting, spreading, blade coating, drop coating or dip coating. The colloidal alumina can be applied onto the inner surface 160 to have a uniform or substantially uniform thickness. The coated colloidal alumina can then be allowed to dry, which can allow the alumina particles 176 to grow as the liquid phase 174 dries away such that the alumina particles 172 form a substantially solid layer of alumina bound to the inner surface 160 to form the lining 170A.

In an example, the colloidal alumina that forms the lining 170A can be applied as a plurality of coats onto the inner surface 160 of the refractory material 152. Each coat of the colloidal alumina can be applied, such as via painting, spraying, or any other coating method, and allowed to dry for a specified period of time before applying a subsequent coat. In an example, from 2 to 10 coats or more can be applied to the inner surface 160, such as 2 coats, 3 coats, 4 coats, 5 coats, 6 coats, 7 coats, 8 coats, 9 coats, or 10 coats. In an example, between coats the lining can be allowed to dry from about 15 minutes to about 6 hours, inclusive, such as from about 30 minutes to about 2 hours, inclusive. After all the coats have been applied, the lining 170A can be allowed to dry for from about 1 hour to about 10 hours, inclusive, such as from about 2 hours to about 8 hours, inclusive, such as from about 4 hours to about 6 hours, inclusive, such as about 4 hours, about 4.5 hours, about 5 hours, about 5.5 hours, and about 6 hours.

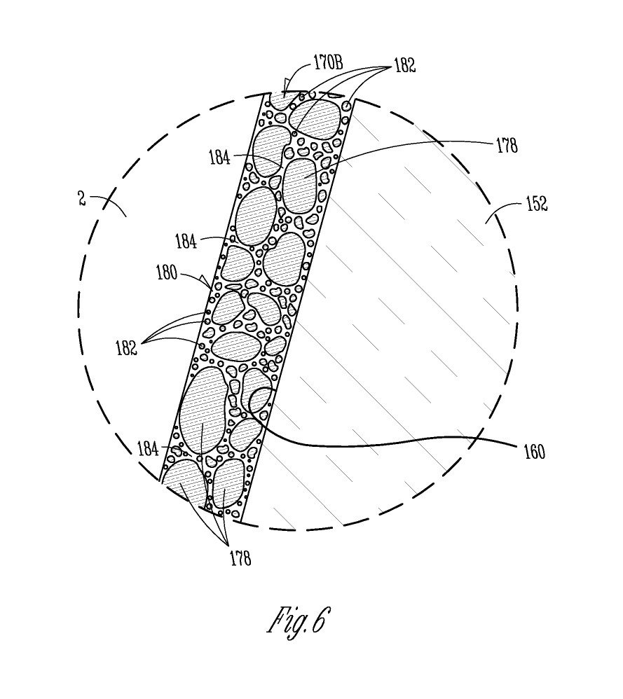

FIG. 6 shows a close-up cross-sectional view of another example of the lining 170B that can be deposited on the inner surface 160 of the refractory material 152. The lining 170B can be similar to the lining 170A described above with respect to FIG. 5. Like the lining 170A, the lining 170B includes alumina formed from colloidal alumina. However, the lining 170B also includes a plurality of particles 178 bound together by a binder 180. The particles 178 can comprise silicon carbide (SiC) and the binder material 180 can comprise a colloidal alumina (Al₂O₃). The SiC particles 178 can each comprise one or more crystals of silicon carbide. The silicon carbide of the particles 178 can act as a barrier to contaminants or impurities, such as boron, phosphorus, and aluminum. The particles 178 can be nanoparticles, e.g., the particles 178 have a size or particle diameter of between 5 nanometers and 50 nanometers, inclusive. In an example, the particles 178 have a size of between 10 nanometers and 30 nanometers, inclusive, such as about 20 nanometers.

The SiC particles 178 can be provided from a commercial supplier. In an example, the SiC particles 178 comprise a high-purity silicon carbide with low levels of contaminants or impurities that can lead to poor performance in photovoltaic devices, such as boron and phosphorus. In an example, the SiC particles 178 can be formed from a commercial silicon carbide having a boron level of less than 3 ppmw, such as less than 2.5 ppmw, for example less than 2.11 ppmw. The commercial silicon carbide can have a phosphorus level of less than 55 ppmw, such as less than 51.5 ppmw, for example less than 50 ppmw. The silicon carbide can have an aluminum level that is less than about 1700 ppmw, such as less than 1675 ppmw, for example less than about 1665 ppmw. The silicon carbide can have an iron level that is less than about 4100 ppmw. The silicon carbide can have a titanium content that is less than about 1145 ppmw. In an example, the SiC particles 178 are free or substantially free of boron and phosphorus. In an example, the SiC particles 178 can comprise other materials, so long as those materials do not cause an unacceptable level of undesirable impurities (such as boron, phosphorous, or aluminum) to leach into the molten material 2. In an example, the SiC particles 178 can include silica (SiO₂), elemental carbon (C), iron (III) oxide (Fe₂O₃), and magnesium oxide (MgO). In an example, the SiC particles 178 have the following composition (on a dry basis): 87.4 wt % SiC, 10.9 wt % SiO₂, 0.9 wet % carbon, 0.5 wt % Fe₂O₃, and 0.1 wt % MgO. In an example, the SiC particles 178 comprise silicon carbide sold under the trade name NANOTEK SiC, sold by Allied Mineral Products, Inc., Columbus, Ohio, USA. The NANOTEK SiC has a high purity with respect to boron, phosphorus, and aluminum, e.g., having about 2.11 ppmw boron, or less, and about 51.4 ppmw phosphorus, or less.

The binder 180 can be formed from a colloidal suspension of alumina (Al₂O₃), referred to herein as colloidal alumina. The colloidal alumina can comprise a suspension of small, amorphous alumina particles 182 suspended in a liquid phase 184. The SiC particles 178 can be mixed into the colloidal alumina binder 180, and then the mixture can be deposited onto the inner surface 160 of the refractory material 152, such as by painting, spreading, or other common liquid deposition techniques. The colloidal alumina binder 180 can act to bind and stabilize the SiC particles 178, even at the high temperatures associated with the presence of the molten material 2.

The colloidal alumina of the binder 180 can be formed via the formation of silica nuclei, followed by growth of the alumina particles 182 within the liquid phase 184. In an example, an alkali silicate solution, such as a sodium silicate solution, is partially neutralized, such as by selective removing at least a portion of the sodium from the sodium silicate. The neutralization of the alkali silicate can lead to the formation of silica nuclei and polymerization of the silica to form amorphous silica particles. The silica nuclei can have a size of between 1 nanometer (nm) and 5 nm, inclusive. The alumina particles 182 can have a size, e.g. a diameter of between 1 nanometer (nm) and 100 nm, inclusive. In an example, the alumina particles 182 have a size of between 10 nm and 30 nm, inclusive, such as about 20 nm. In an example, the colloidal silica that forms the binder 180 has a weight percentage of the alumina particles 182 that is between 25 wt % and 60 wt % silica, inclusive, such as between 30 wt % and 50 wt % silica, inclusive, for example 40 wt % silica.

In an example, the colloidal alumina used to make the lining 170B is a commercially-available colloidal alumina, such as the colloidal alumina sold under the trade name WESOL by WesBond Corp., Wilmington, Del., USA.

The SiC particles 178 and the binder 180 can be mixed together to form a precursor mixture that can be deposited onto the inner surface 160 to form the lining 170B. The SiC particles 178 and the binder 180 can be mixed together in a weight ratio that can provide for coatability or spreadability of the precursor mixture, good slumping characteristics (e.g., a lack of slumping or minimal slumping after being spread), an acceptable drying time (e.g., long enough so that the mixture can be fully applied to the inner surface 160 before drying, but short enough to provide for a reasonable drying time within the manufacturing process), acceptable binding strength to the refractory material 152, and acceptable resistance to transmission of impurities or contaminants from the refractory material 152 to the molten material 2. In an example, the lining 170B comprises a weight composition of between 30 wt % SiC particles 178 and 80 wt % SiC particles 178, inclusive (e.g., between 20 wt % colloidal alumina binder 180 and 70 wt % colloidal alumina binder 180, inclusive), such as between 50 wt % SiC particles 178 and 70 wt % SiC particles 178, inclusive (e.g., between 30 wt % colloidal alumina binder 180 and 50 wt % colloidal alumina binder 180, inclusive), for example about 40 wt % SiC particles 178 and about 60 wt % colloidal alumina binder 180. After drying (e.g., after removal of water and other liquids from the colloidal alumina binder 180), the resulting lining 170B can be from 35 wt % SiC to 95% wt % SiC, inclusive (e.g., from 5 wt % silica to 65 wt % silica, inclusive), such as from 60 wt % SiC to 90 wt % SiC, inclusive (e.g., from 10 wt % silica to 40 wt % silica, inclusive), for example from 70 wt % SiC to 85 wt % SiC, inclusive (e.g., from 15 wt % silica to 30 wt % silica, inclusive), such as about 80 wt % SiC and about 20 wt %.

In an example, the mixture of the SiC particles 178 and the colloidal alumina binder 180 can be a liquid or liquid suspension that can be coated onto the inner surface 160 by known liquid coating methods. In an example, the mixture can be coated onto the inner surface 160 via at least one of painting, spraying, spreading, blade coating, drop coating or dip coating. The mixture of the SiC particles 178 and the colloidal alumina binder 180 can be applied onto the inner surface 160 to have a uniform or substantially uniform thickness. The coated mixture can then be allowed to dry, which can allow the alumina particles 182 to grow as the liquid phase 184 dries away such that the SiC particles 178 become bound by a substantially solid alumina binder 180 to form the lining 170B.

In an example, the mixture of the SiC particles 178 and the colloidal alumina binder 180 can be applied as a plurality of coats onto the inner surface 160 of the refractory material 152. Each coat of the mixture can be applied, such as via painting, spraying, or any other coating method, and allowed to dry for a specified period of time before applying a subsequent coat. In an example, from 2 to 10 coats or more can be applied to the inner surface 160, such as 2 coats, 3 coats, 4 coats, 5 coats, 6 coats, 7 coats, 8 coats, 9 coats, or 10 coats. In an example, between coats the lining can be allowed to dry from about 15 minutes to about 6 hours, inclusive, such as from about 30 minutes to about 2 hours, inclusive. After all the coats have been applied, the lining 170B can be allowed to dry for from about 1 hour to about 10 hours, inclusive, such as from about 2 hours to about 8 hours, inclusive, such as from about 4 hours to about 6 hours, inclusive, such as about 4 hours, about 4.5 hours, about 5 hours, about 5.5 hours, and about 6 hours.

The thickness of the lining 170 (either the lining 170A of FIG. 5 or the lining 170B of FIG. 6) can depend on the conditions within and around the crucible 150 and on the stage of processing that is being performed within the crucible 150. For example, if the crucible 150 is being used as a melting crucible in order to melt a solid silicon to form the molten material 2, than a relatively thick lining 170 can be required due to the high temperature throughout the crucible 150 because the crucible 150 is placed within a furnace. Similarly, if the crucible 150 is being used as a mold for directional solidification, then a relatively thin lining 170 can be required due to a less volatile environment within the molten material 2 and a relatively lower temperature. In an example, the lining 170 has a thickness from about 1 millimeter (mm) to about 25 mm, inclusive, such as from about 2 mm to about 15 mm, inclusive, for example, from about 3 mm to about 10 mm, for example from about 4 mm to about 5 mm, inclusive, such as about 4, about 4.1 mm, about 4.2 mm, about 4.3 mm, about 4.4 mm, about 4.5 mm, about 4.6 mm, about 4.7 mm, about 4.8 mm, about 4.9 mm, about 5 mm, about 5.1 mm, about 5.2 mm, about 5.3 mm, about 5.4 mm, about 5.5 mm, about 5.6 mm, about 5.7 mm, about 5.8 mm, about 5.9 mm, and about 6 mm.

In an example, the crucible 150 can hold about 1 metric tonne of molten silicon, or more. In an example, the crucible 150 can hold about 1.4 metric tonnes of molten silicon, or more. In an example, the crucible 150 can hold about 2.1 metric tonnes of molten silicon, or more. In an example, the crucible 150 can hold at least about 1, 1.2, 1.4, 1.6, 1.8, 2.0, 2.1, 2.5, 3, 3.5, 4, 4.5, or 5 metric tonnes of silicon molten, or more.

To better illustrate the method and apparatuses disclosed herein, a non-limiting list of embodiments is provided here:

Embodiment 1 includes a crucible for containing a molten silicon mixture, the crucible comprising at least one refractory material having at least one inner surface defining an interior for receiving a molten silicon mixture, and a lining deposited onto the inner surface, the lining comprising colloidal alumina.

Embodiment 2 includes the crucible of Embodiment 1, wherein the lining prevents or reduces contamination of molten silicon mixture contained within the interior of the body from the at least one refractory material.

Embodiment 3 includes the crucible of Embodiment 2, wherein the lining prevents contamination of the molten silicon from at least one of boron and phosphorous.

Embodiment 4 includes the crucible of any one of Embodiments 1-3, wherein the colloidal alumina comprises alumina particles suspended in water, the alumina particles having a size between 20 nanometers and 50 nanometers, inclusive.

Embodiment 5 includes the crucible of any one of Embodiments 1-4, wherein the lining has a thickness of between 2 millimeters and 10 millimeters, inclusive.

Embodiment 6 includes the crucible of any one of Embodiments 1-5, wherein the at least one refractory material comprises alumina.

Embodiment 7 includes the crucible of any one of Embodiments 1-6, wherein the lining further comprises silicon carbide particles bound by the colloidal alumina.

Embodiment 8 includes the crucible of Embodiment 7, wherein the silicon carbide particles have a size of less than about 3.5 millimeters.

Embodiment 9 includes the crucible of any one of Embodiments 1-8, wherein the crucible is configured for melting a mixture of silicon and aluminum to form the molten silicon mixture.

Embodiment 10 includes a method for the purification of silicon, the method comprising contacting a first silicon with a solvent metal comprising aluminum, sufficient to provide a first mixture, melting the first mixture in an interior of a melting crucible to provide a molten silicon mixture, the melting crucible comprising at least one refractory material having an inner surface defining the interior of the melting crucible, coating at least a portion of the inner surface of the melting crucible with a lining comprising colloidal alumina prior to melting first mixture, cooling the molten silicon mixture, sufficient to form recrystallized silicon crystals and a mother liquor, and separating the final recrystallized silicon crystals and the mother liquor.

Embodiment 11 includes the method of Embodiment 10, wherein the lining prevents or reduces contamination of the molten silicon mixture from the at least one refractory material.

Embodiment 12 includes the method of Embodiment 11, wherein the lining prevents contamination of the molten silicon mixture from at least one of boron and phosphorous.

Embodiment 13 includes the method of Embodiment 12, wherein the colloidal alumina comprises alumina particles suspended in water, the alumina particles have a size between 20 nanometers and 50 nanometers, inclusive.

Embodiment 14 includes the method of any one of Embodiments 10-13, wherein the lining has a thickness of between 2 millimeters and 10 millimeters, inclusive.

Embodiment 15 includes the method of any one of Embodiments 10-14, wherein the lining further comprises silicon carbide particles bound by the colloidal alumina.

Embodiment 16 includes the method of Embodiment 15, wherein the silicon carbide particles have a size of less than about 3.5 millimeters.

Embodiment 17 includes the method of any one of Embodiments 10-16, wherein the at least one refractory material comprises alumina.

Embodiment 18 includes a method for the purification of silicon, the method comprising contacting a first silicon with a first solvent metal, sufficient to provide a first mixture, coating at least a portion of a first inner surface of a first refractory of a first melting crucible with a first lining comprising colloidal alumina, melting the first mixture in an interior of the first melting crucible to provide a first molten silicon mixture, cooling the first molten silicon mixture, sufficient to form first silicon crystals and a first mother liquor, separating the first silicon crystals and the first mother liquor, contacting the first silicon crystals with a second solvent metal, sufficient to provide a second mixture, coating at least a portion of a second inner surface of a second refractory of a second melting crucible with a second lining comprising colloidal alumina, melting the second mixture in an interior of the second melting crucible to provide a second molten silicon mixture, cooling the second molten silicon mixture, sufficient to form second silicon crystals and a second mother liquor, and separating the second silicon crystals and the second mother liquor.

Embodiment 19 includes the method of Embodiment 18, wherein at least a portion of the first solvent metal comprises at least one of: at least a portion of the first mother liquor and at least a portion of the second mother liquor.

Embodiment 20 includes the method of either one of Embodiments 18 or 19, wherein at least a portion of the second solvent metal comprises at least one of at: least a portion of the first mother liquor and at least a portion of the second mother liquor.

Embodiment 21 includes the method of any one of Embodiments 18-20, further comprising contacting the second silicon crystals with a third solvent metal, sufficient to provide a third mixture, coating at least a portion of a third inner surface of a third refractory of a third melting crucible with a third lining comprising colloidal alumina, melting the third mixture in an interior of the third melting crucible to provide a third molten silicon mixture, cooling the third molten silicon mixture, sufficient to form third silicon crystals and a third mother liquor, and separating the third silicon crystals and the third mother liquor.

Embodiment 22 includes the method of Embodiment 21, wherein at least a portion of the first solvent metal comprises at least a portion of the third mother liquor.

Embodiment 23 includes the method of either one of Embodiments 21 or 22, wherein at least a portion of the second solvent metal comprises at least a portion of the third mother liquor.

Embodiment 24 includes the method of any one of Embodiments 21-23, wherein at least a portion of the third solvent metal comprises at least one of: at least a portion of the first mother liquor, at least a portion of the second mother liquor, and at least a portion of the third mother liquor.

The above detailed description includes references to the accompanying drawings, which form a part of the detailed description. The drawings show, by way of illustration, specific examples in which the invention can be practiced. These examples are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed example. Thus, the following claims are hereby incorporated into the Detailed Description as examples or examples, with each claim standing on its own as a separate example, and it is contemplated that such examples can be combined with each other in various combinations or permutations. The scope of the invention should be determined with reference to the appended claims, along with the full scope of equivalents to which such claims are entitled.

1. A crucible for containing a molten silicon mixture, the crucible comprising:
at least one refractory material having at least one inner surface defining an interior for receiving a molten silicon mixture;
a lining deposited onto the inner surface, the lining comprising colloidal alumina.

2. (canceled)

3. The crucible of claim 1, wherein the lining prevents contamination of the molten silicon from at least one of boron and phosphorous contained within the interior of the at least one refractory material.

4. The crucible of claim 1, wherein the colloidal alumina comprises alumina particles suspended in water, the alumina particles having a size between 20 nanometers and 50 nanometers, inclusive.

5. The crucible of claim 1, wherein the lining has a thickness of between 2 millimeters and 10 millimeters, inclusive.

6. The crucible of claim 1, wherein the at least one refractory material comprises alumina.

7. The crucible of claim 1, wherein the lining further comprises silicon carbide particles bound by the colloidal alumina.

8. The crucible of claim 7, wherein the silicon carbide particles have a size of less than about 3.5 millimeters.

9. (canceled)

10. A method for the purification of silicon, the method comprising:
contacting a first silicon with a solvent metal comprising aluminum, to provide a first mixture;
melting the first mixture in an interior of a melting crucible to provide a molten silicon mixture, the melting crucible comprising at least one refractory material having an inner surface defining the interior of the melting crucible;
coating at least a portion of the inner surface of the melting crucible with a lining comprising colloidal alumina prior to melting the first mixture;
cooling the molten silicon mixture, to form recrystallized silicon crystals and a mother liquor; and
separating the final recrystallized silicon crystals and the mother liquor.

11. (canceled)

12. The method of claim 10, wherein the lining prevents contamination of the molten silicon mixture from at least one of boron and phosphorous from the at least one refractory material.

13. The method of claim 10, wherein the colloidal alumina comprises alumina particles suspended in water, the alumina particles have a size between 20 nanometers and 50 nanometers, inclusive.

14. The method of claim 10, wherein the lining has a thickness of between 2 millimeters and 10 millimeters, inclusive.

15. The method of claim 10, wherein the lining further comprises silicon carbide particles bound by the colloidal alumina.

16. The method of claim 15, wherein the silicon carbide particles have a size of less than about 3.5 millimeters.

17. The method of claim 10, wherein the at least one refractory material comprises alumina.

18. A method for the purification of silicon, the method comprising:
contacting a first silicon with a first solvent metal, to provide a first mixture;
coating at least a portion of a first inner surface of a first refractory of a first melting crucible with a first lining comprising colloidal alumina;
melting the first mixture in an interior of the first melting crucible to provide a first molten silicon mixture;
cooling the first molten silicon mixture, to form first silicon crystals and a first mother liquor;
separating the first silicon crystals and the first mother liquor;
contacting the first silicon crystals with a second solvent metal, to provide a second mixture;
coating at least a portion of a second inner surface of a second refractory of a second melting crucible with a second lining comprising colloidal alumina;
melting the second mixture in an interior of the second melting crucible to provide a second molten silicon mixture;
cooling the second molten silicon mixture, to form second silicon crystals and a second mother liquor; and
separating the second silicon crystals and the second mother liquor.

19. The method of claim 18, wherein at least a portion of the first solvent metal comprises at least one of: at least a portion of the first mother liquor and at least a portion of the second mother liquor.

20. The method of claim 18, wherein at least a portion of the second solvent metal comprises at least one of at: least a portion of the first mother liquor and at least a portion of the second mother liquor.

21. The method of claim 18, further comprising:
contacting the second silicon crystals with a third solvent metal, to provide a third mixture;
coating at least a portion of a third inner surface of a third refractory of a third melting crucible with a third lining comprising colloidal alumina;
melting the third mixture in an interior of the third melting crucible to provide a third molten silicon mixture;
cooling the third molten silicon mixture, to form third silicon crystals and a third mother liquor; and
separating the third silicon crystals and the third mother liquor.

22-24. (canceled)
